(19) United States
(12) Patent Application Publication
(10) Pub. No.: US 2025/0365038 A1
(43) Pub. Date: Nov. 27, 2025

(54) SIGNAL PROCESSING APPARATUS AND SIGNAL PROCESSING METHOD

(71) Applicant: NIPPON TELEGRAPH AND TELEPHONE CORPORATION, Tokyo (JP)

(72) Inventors: Kazumitsu SAKAMOTO, Musashino-shi (JP); Yosuke FUJINO, Musashino-shi (JP); Kohei SUZAKI, Musashino-shi (JP); Yohei KATAYAMA, Musashino-shi (JP); Kenji SUZUKI, Musashino-shi (JP); Yasuyoshi KOJIMA, Musashino-shi (JP); Kiyohiko ITOKAWA, Musashino-shi (JP); Fumihiro YAMASHITA, Musashino-shi (JP)

(21) Appl. No.: 19/108,355

(22) PCT Filed: Sep. 7, 2022
(86) PCT No.: PCT/JP2022/033587

§ 371 Date: Mar. 3, 2025

(51) Int. Cl. H04B 7/01

(52) U.S. Cl. CPC H04B 7/01

(57) ABSTRACT

A signal processing apparatus includes a timing correction unit, a frame detection unit, a beam control unit, and a decoding unit. The timing correction unit detects sample timing deviations among reception systems on the basis of known signal sections included in waveform data having been obtained by sampling waveforms of radio signals having been received by a communication apparatus using the plurality of reception systems and performs processing of correcting the detected sample timing deviations on the waveform data. The frame detection unit detects frames of radio signals in the waveform data with the sample timing deviations corrected and performs compensation for a Doppler shift on the detected frames. The beam control unit performs reception beam control on the plurality of frames on which the compensation for the Doppler shift has been performed. The decoding unit decodes signals having been obtained through the reception beam control and obtains data having been transmitted by the radio signals.

### TECHNICAL FIELD

The present invention relates to a signal processing apparatus and a signal processing method.

### BACKGROUND ART

In recent years, satellite Internet of Things (IoT) platforms (satellite IoT-PFs) have been studied. A satellite IoT-PF collects sensor data from IoT terminals anywhere on the Earth using a low Earth orbiting satellite. An installation place of the IoT terminal includes an area that is difficult to cover in a terrestrial communication network such as on the sea or in a mountain area.

FIG. 13 is a diagram illustrating a radio signal received by a low orbit satellite on a satellite IoT-PF. In FIG. 13, a solid arrow represents a desired signal from the satellite IoT terminal, and a broken arrow represents an interference signal from a ground IoT terminal. The satellite IoT terminal is a target for collecting data on the satellite IoT-PF. The low orbit satellite receives not only the desired signals transmitted arriving from a large number of satellite IoT terminals but also a large number of interference signals arriving from the ground IoT terminals widely spread on the ground. Therefore, the satellite IoT-PF needs to extract a weak desired signal transmitted from a desired satellite IoT terminal and perform demodulation and decoding while these signals interfere with each other. As an effective method for this purpose, there is a method of mounting a plurality of reception antennas on a low orbit satellite and performing reception beam control using these reception antennas (see Non Patent Literature 1, for example).

In addition, the low orbit satellite is generally required to be small, lightweight, and power saving. Meanwhile, there are many types of low power wide area (LPWA) methods used by the IoT terminals, such as LoRa (registered trademark), Sigfox (registered trademark), and ELTRES (registered trademark). When the low orbit satellite includes a receiver that performs demodulation and decoding of each LPWA method, the receiver becomes complicated, which leads to an increase in power consumption. Furthermore, a low orbit satellite performing reception beam control, extracting desired signals from a large number of desired satellite IoT terminals and demodulating and decoding the extracted signals also leads to an increase in power consumption since a large amount of signal processing is required in the low orbit satellite. In addition, if a new LPWA method were developed, a low orbit satellite does not include a receiver that is compatible with the LPWA method and thus would not be able to perform normal reception.

Therefore, a system configuration in which an apparatus on the ground performs the reception beam control by offline signal processing has been studied (see Non Patent Literature 2, for example). In this system configuration, a plurality of reception antennas is mounted on a low orbit satellite. The low orbit satellite transmits sampled received waveform data of each reception antenna to the ground. The apparatus on the ground performs the reception beam control for a signal obtained from the received waveform data by offline signal processing to extract the desired signal from the satellite IoT terminal. Also, there is a commercially available radio frequency (RF) chip with a waveform sampling function (see Non Patent Literature 3, for example).

### CITATION LIST

### Non Patent Literature

Non Patent Literature 1: J. Chu, X. Chen, C. Zhong and Z. Zhang, “Robust Design for NOMA-Based Multibeam LEO Satellite Internet of Things”, IEEE Internet of Things Journal, vol. 8, no. 3, pp. 1959-1970, 2021.
Non Patent Literature 2: F. Yamashita, D. Goto, Y. Kojima, M. Matsui, K. Itokawa, K. Yoshizawa, K. Sakamoto, Y. Fujino, C. Kato, and M. Nakadai, “920-MHZ IoT platform via LEO satellite employing feeder-link MIMO technology,” Proc. 2020 International Conference on Emerging Technologies for Communications (ICETC2020), A1-2, December 2020.
Non Patent Literature 3: Semtech, SX1257 Data Sheet Rev. 1.2, March 2018.

### SUMMARY OF INVENTION

### Technical Problem

The low orbit satellite has an IoT reception system corresponding to each reception antenna. In each IoT reception system, it is desired to perform sampling in a state where sample timings are synchronized with each other in order to secure performance of reception beam control. In a case where there is a sample timing deviation among the reception systems, characteristic degradation of the reception beam control is caused particularly in the LoRa (registered trademark) method or the LPWA method with a high transmission rate.

For example, LoRa (registered trademark) is a Chirp spreading method. In this method, the sample timing deviation leads to a frequency deviation. In other words, if sample timing deviation occurs, signals with frequency deviations are synthesized when signals of the respective reception systems are synthesized, and this leads to characteristic degradation of reception beam control. Also, synthesis of symbol points cannot be performed due to sample timing deviations in the LPWA method with a high transmission rate, and this leads to characteristic degradation.

In order to perform sampling in a state where sample timings are accurately synchronized in each reception system, it is necessary to mount a dedicated sampling device on a satellite. This leads to an increase in cost of the sampling device and an increase in development period. In addition, in a case where waveform sampling is performed by mounting a plurality of commercially available RF chips having a waveform sampling function as described in Non Patent Literature 3, sample timing deviations occur due to slight time differences among power-on timings in the RF chips of the respective reception systems.

In view of the above circumstances, an object of the present invention is to provide a signal processing apparatus and a signal processing method capable of reducing characteristic degradation of reception beam control even in a case where sample timing deviations of reception waveforms occur among reception systems of radio signals.

### Solution to Problem

A signal processing apparatus according to an aspect of the present invention includes: a first timing correction unit that detects sample timing deviations among a plurality of reception systems on a basis of known signal sections included in waveform data having been obtained by sampling waveforms of radio signals having been received by a communication apparatus using each of the plurality of reception systems and performs processing of correcting the detected sample timing deviations on the waveform data; a frame detection unit that detects frames of radio signals in the waveform data with the sample timing deviations corrected and performs compensation for a Doppler shift on the detected frames; a beam control unit that performs reception beam control on the plurality of frames on which the compensation for the Doppler shift has been performed; and a decoding unit that decodes signals having been obtained through the reception beam control and obtains data having been transmitted by the radio signals.

A signal processing method according to an aspect of the present invention includes: a timing correction step of detecting sample timing deviations among a plurality of reception systems on a basis of known signal sections included in waveform data having been obtained by sampling waveforms of radio signals having been received by a communication apparatus using each of the plurality of reception systems and performing processing of correcting the detected sample timing deviations on the waveform data; a frame detection step of detecting frames of radio signals in the waveform data with the sample timing deviations corrected and performing compensation for a Doppler shift on the detected frames; a reception beam control step of performing reception beam control on the plurality of frames on which the compensation for the Doppler shift has been performed; and a decoding step of decoding signals having been obtained through the reception beam control and obtaining data having been transmitted by the radio signals.

### Advantageous Effects of Invention

According to the present invention, it is possible to reduce characteristic degradation of reception beam control even in a case where sample timing deviations of a reception waveforms occur among reception systems of radio signals.

### BRIEF DESCRIPTION OF DRAWINGS

FIG. 1 A diagram illustrating a configuration of a wireless communication system according to the first embodiment of the present invention.

FIG. 2 A diagram for explaining processing of detecting and correcting a sample timing deviation according to the first embodiment.

FIG. 3 A diagram illustrating a known signal section of a signal frame used in the first embodiment.

FIG. 4 A diagram illustrating a two-dimensional distribution of correlation values in the first embodiment.

FIG. 5 A flowchart illustrating processing of the wireless communication system according to the first embodiment.

FIG. 6 A flowchart illustrating processing of the wireless communication system according to the first embodiment.

FIG. 7 A flowchart illustrating processing of a timing correction unit according to the first embodiment.

FIG. 8 A block diagram illustrating a configuration of a signal processing unit according to the first embodiment.

FIG. 9 A diagram illustrating a configuration of a wireless communication system according to the second embodiment.

FIG. 10 A diagram for explaining processing of detecting and correcting a sample timing deviation according to the second embodiment.

FIG. 11 A flowchart illustrating processing of the wireless communication system according to the second embodiment.

FIG. 12 A flowchart illustrating processing of a signal processing unit according to the second embodiment.

FIG. 13 A diagram illustrating a radio signal received by a low orbit satellite in a satellite IoT-PF.

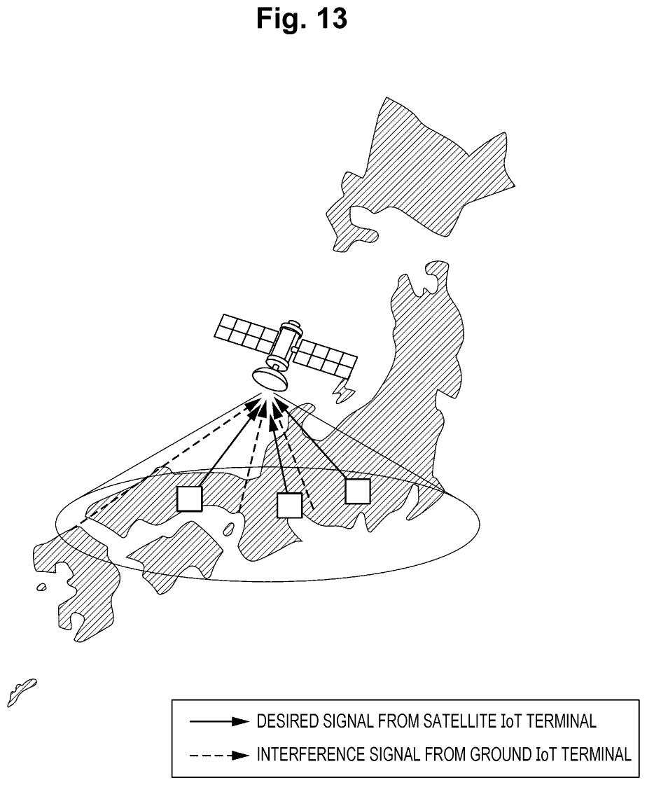

### DESCRIPTION OF EMBODIMENTS

Hereinafter, embodiments of the present invention will be described in detail with reference to the drawings. Note that the same parts will be denoted by the same reference signs in the drawings, and the description thereof will be omitted.

### First Embodiment

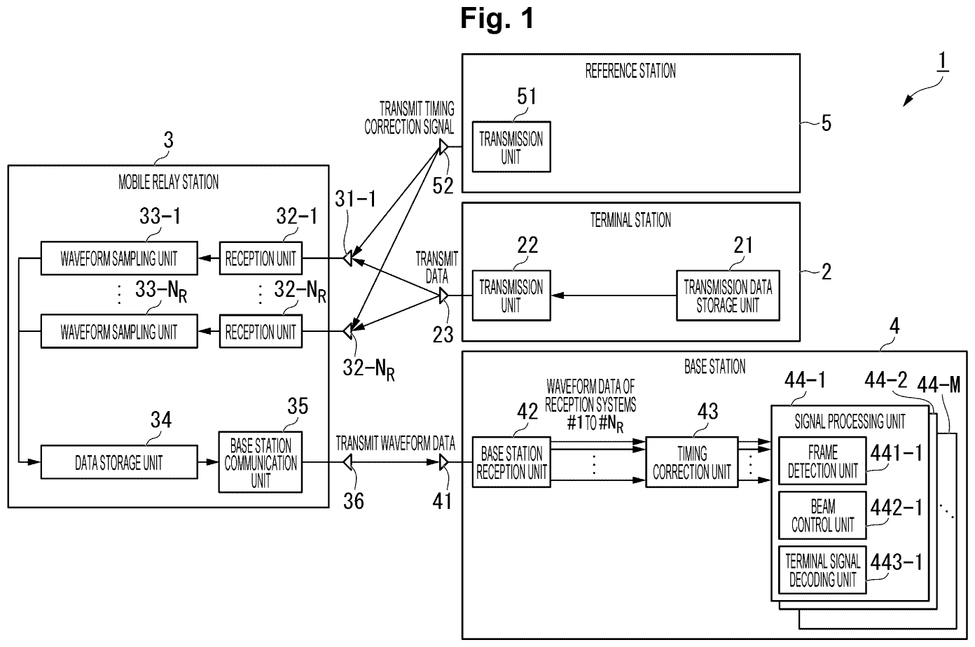

FIG. 1 is a diagram illustrating a configuration of a wireless communication system 1 according to a first embodiment of the present invention. A wireless communication system 1 includes a terminal station 2, a mobile relay station 3, a base station 4, and a reference station 5. The base station 4 is an example of a signal processing apparatus. In the wireless communication system 1, the numbers of the terminal stations 2, the mobile relay stations 3, the base stations 4, and the reference stations 5 are any numbers. Note that it is supposed that the number of terminal stations 2 is large. The mobile relay station 3 moves through the sky above the earth. The terminal stations 2, the base stations 4, and the reference station 5 are installed on the earth. The earth includes the ground and the sea.

Hereinafter, radio signals transmitted from the terminal stations 2 to the mobile relay stations 3 and radio signals transmitted from the reference stations 5 to the mobile relay stations 3 will be referred to as “uplink signals”. Among the uplink signals, radio signals transmitted from the terminal stations 2 to the mobile relay stations 3 will be referred to as “terminal uplink signals”. Further, radio signals transmitted from the mobile relay stations 3 to the base stations 4 will be referred to as “downlink signals”.

The terminal stations 2 are, for example, satellite IoT terminals. Each terminal station 2 includes a transmission data storage unit 21, a transmission unit 22, and an antenna 23. Although FIG. 1 illustrates an example in which one antenna 23 is provided, two or more antennas 23 may be provided.

The transmission data storage unit 21 stores transmission data. The transmission data is, for example, environment data or the like detected by a sensor. The transmission unit 22 generates the terminal uplink signal in which the transmission data read from the transmission data storage unit 21 is set. The transmission unit 22 transmits the terminal uplink signal from the antenna 23 toward the mobile relay station 3 moving over the sky by a wireless scheme used in a satellite IoT platform. The transmission unit 22 transmits the signal by, for example, low power wide area (LPWA) method. The LPWA method includes LoRaWAN (registered trademark), Sigfox (registered trademark), long term evolution for machines (LTE-M), narrow band (NB)-IoT, and the like, and any wireless communication scheme can be used. Moreover, the transmission unit 22 may perform transmission with another terminal station 2 by time division multiplexing, orthogonal frequency division multiplexing (OFDM), or the like. The transmission unit 22 determines a channel and a transmission timing to be used for transmission of a terminal uplink signal by its own station by a method determined in advance in a wireless communication scheme to be used.

The mobile relay station 3 is an example of a communication apparatus that moves over time. The mobile relay station 3 moves through the sky by being mounted on a moving body. The mobile relay station 3 is provided in, for example, a low earth orbit (LEO) satellite. The mobile relay station 3 travels around the earth along a predetermined orbit. The LEO satellite has an altitude of 2000 km or less and travels around the earth once every about 1.5 hours. The mobile relay station 3 receives the terminal uplink signal from each terminal station 2 while moving through the sky above the earth. The mobile relay station 3 accumulates data received by the terminal uplink signal. The mobile relay station 3 transmits the accumulated data to the base station 4 using the downlink signal at timing at which communication with the base station 4 is possible.

Since the mobile relay station 3 mounted on the LEO satellite performs communication while moving at a high speed, a time during which each terminal station 2 or the base station 4 can communicate with the mobile relay station 3 is limited. Specifically, when viewed on the ground, the mobile relay station 3 passes through the sky in about several minutes. Therefore, the mobile relay station 3 mounted in the LEO satellite has a smaller link budget as compared with a case where the relay station is mounted in a drone or a high altitude platform station (HAPS), for example. Therefore, the mobile relay station 3 receives terminal uplink signals from the terminal stations 2 in coverage at a current position during moving through the plurality of reception antennas and stores waveform data obtained by sampling waveforms of the terminal uplink signals received by the respective reception antennas. For example, multiple input multiple output (MIMO) is used for the reception using the plurality of reception antennas. A communication quality can be improved according to a diversity effect and a beamforming effect in the communication using the plurality of reception antennas.

The mobile relay station 3 includes antennas 31-1 to 31-N_{R} (N_{R} is an integer that is equal to or greater than 2), reception units 32-1 to 32-N_{R}, waveform sampling units 33-1 to 33-N_{R}, a data storage unit 34, a base station communication unit 35, and an antenna 36. Although FIG. 1 illustrates an example in which one antenna 36 is provided, two or more antennas 36 may be provided.

The antennas 31-1 to 31-N_{R} are used for wireless communication with the terminal station 2 and the reference station 5. The antennas 31-1 to 31-N_{R} correspond to reception antennas of uplink signals. On the other hand, the antenna 36 is used for radio communication with the base station 4. A frequency used for wireless communication with the terminal station 2 and the reference station 5 is generally different from a frequency used for wireless communication with the base station 4. Therefore, the mobile relay station 3 can execute the wireless communication related to the terminal station 2 and the reference station 5 and the wireless communication related to the base station 4 in parallel.

The reception unit 32-n and the waveform sampling unit 33-n are an n-th IoT reception system of the mobile relay station 3 and correspond to the antenna 31-n (n is an integer that is equal to or greater than 1 and equal to or less than N_{R}). The n-th IoT reception system will be referred to as an IoT reception system #n or a reception system #n. The reception unit 32-n receives an uplink signal through the antenna 31-n. The waveform sampling unit 33-n samples the reception waveform of the uplink signal received by the reception unit 32-n and stores the waveform data obtained by the sampling in the data storage unit 34. As the waveform sampling unit 33-n, a commercially available RF chip can be used. The RF chip used as the waveform sampling unit 33-n down-converts the uplink signal of the radio frequency (RF) signal received by the reception unit 32-n, and samples the reception waveform of the down-converted uplink signal. The base station communication unit 35 transmits the downlink signal to the base station 4 at a timing when the base station 4 exists in the coverage. The waveform data read from the data storage unit 34 is set in the downlink signal.

The base station 4 includes an antenna 41, a base station reception unit 42, a timing correction unit 43, and M (M is an integer that is equal to or greater than 1) signal processing units 44. Although FIG. 1 illustrates an example in which one antenna 41 is provided, two or more antennas 41 may be provided. Each of the plurality of antennas 41 may be provided in antenna stations geographically separated from each other. The M signal processing units 44 will be referred to as signal processing units 44-1 to 44-M, respectively.

The base station reception unit 42 receives the downlink signal from the mobile relay station 3 using the antenna 41. The base station reception unit 42 obtains waveform data of each of the IoT reception systems #1 to #N_{R} from the received downlink signal. The base station reception unit 42 outputs the obtained waveform data to the timing correction unit 43.

The waveform data of the IoT reception systems #1 to #N_{R} may not be synchronized due to a deviations of sample timings among the IoT reception systems of the mobile relay station 3. Therefore, the timing correction unit 43 detects relative deviations of sample timings among the IoT reception systems. In order to detect the relative deviations, the waveform data of the terminal correction signal transmitted from the reference station 5 is used similarly to the terminal uplink signal. The terminal correction signal is, for example, a LoRa (registered trademark) signal having high timing detection resolution. The timing correction unit 43 performs processing of correcting the detected relative deviations on the waveform data of each of the IoT reception systems #1 to #N_{R} and then outputs the waveform data to the signal processing unit 44.

Each of the signal processing units 44-1 to 44-M performs signal processing of different LPWA methods. The LPWA method corresponding to the signal processing unit 44-m (m is an integer that is equal to or greater than 1 and equal to or less than M) will be referred to as an LPWA method #m. The signal processing unit 44 performs processing such as frame detection (terminal signal detection), Doppler shift compensation, and reception beam control on the waveform data of the IoT reception systems #1 to #N_{R}. In the present embodiment, description of other reception processing performed by general wireless communication apparatus is omitted. The signal processing unit 44 includes a frame detection unit 441, a beam control unit 442, and a terminal signal decoding unit 443. The frame detection unit 441, the beam control unit 442, and the terminal signal decoding unit 443 of the signal processing unit 44-m will be referred to as a frame detection unit 441-m, a beam control unit 442-m, and a terminal signal decoding unit 443-m, respectively.

The frame detection unit 441-m detects a frame of the LPWA method #m in the waveform data of the LOT reception systems #1 to #N_{R} input from the timing correction unit 43. The frame detection is processing of detecting a frame section from the waveform data. The frame section is a section including a terminal transmission frame of the terminal uplink signal.

Furthermore, the frame detection unit 441-m compensates for Doppler shift of the frame section in each piece of waveform data. The compensation for the Doppler shift may include compensation for a Doppler shift variation. Note that the Doppler shift variation is a variation of the Doppler shift per unit time. The frame detection unit 441-m outputs the waveform data of the frame section with the Doppler shift of each of the IoT reception systems #1 to #N_{R} compensated to the beam control unit 442-m.

The beam control unit 442-m inputs the waveform data of the frame sections of the IoT reception systems #1 to #N_{R} from the frame detection unit 441-m, and performs reception beam control. In the reception beam control, the beam control unit 442-m multiplies the waveform data of the frame section of each of the IoT reception systems #1 to #N_{R} by a weight for performing amplitude correction and phase correction for intensifying and synthesizing a desired signal of each IoT reception system while curbing an interference signal, and then adds and synthesizes the waveform data. The beam control unit 442-m outputs the added and synthesized waveform data to the terminal signal decoding unit 443-m as a reception signal.

The terminal signal decoding unit 443-m inputs the reception signal obtained through the reception beam control from the beam control unit 442-m. The terminal signal decoding unit 443-m decodes a symbol of the input reception signal and obtains the terminal transmission data transmitted from the terminal station 2.

The reference station 5 includes a transmission unit 51 and an antenna 52. The transmission unit 51 transmits a timing correction signal from the antenna 52 to the mobile relay station 3.

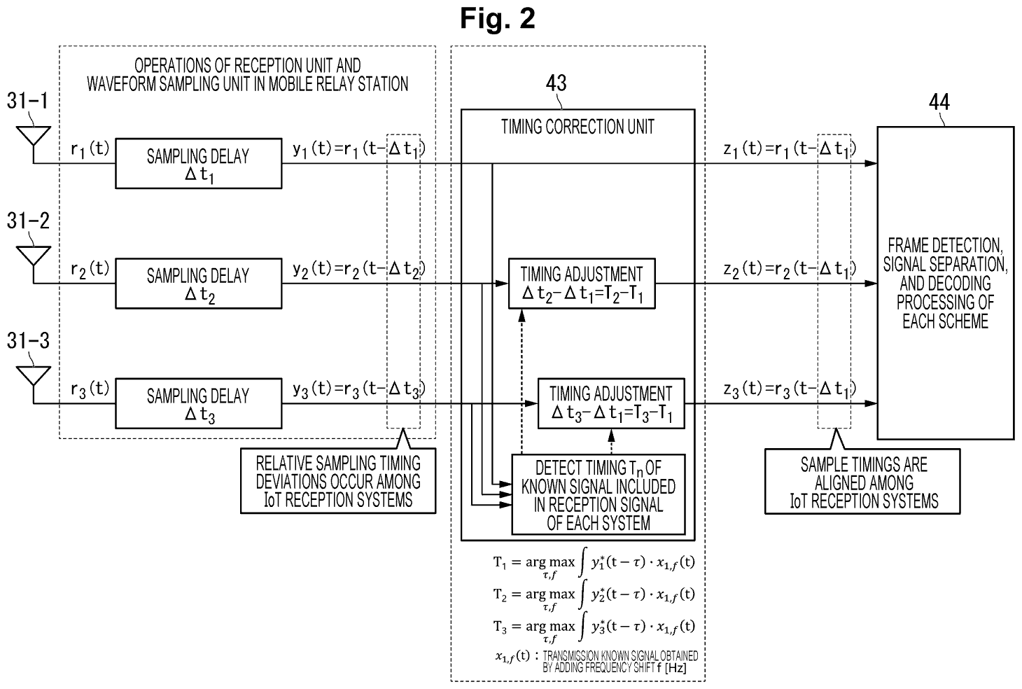

FIG. 2 is a diagram for explaining processing of detecting and correcting sample timing deviations among the IoT reception systems in the wireless communication system 1. FIG. 2 illustrates an example of a case where N_{R}=3. The detection and correction of the relative deviations of the sample timings among the IoT reception systems are performed by the base station 4 which is a ground demodulation system. The timing correction unit 43 of the base station 4 detects and corrects a relative deviations of the sample timings through correlation processing between the timing correction signal and the known signal.

The reception unit 32-n of the mobile relay station 3 receives an uplink signal rₙ through the antenna 31-n. The uplink signal is a terminal uplink signal transmitted by the terminal station 2 using an arbitrary LPWA method and a timing correction signal transmitted by the reference station. Here, it is assumed that the LPWA method used for the timing correction signal is LoRa (registered trademark). The waveform sampling unit 33-n samples the reception waveform of the terminal uplink signal rₙ received by the reception unit 32-n and obtains waveform data yₙ. A sampling delay Δtₙ occurs until the waveform data yₙ(t) is obtained after the reception of the uplink signal rₙ(t) at clock time t. Therefore, the waveform data yₙ(t) at the clock time t can be expressed as rₙ(t−Δtₙ). The mobile relay station 3 transmits the waveform data yₙ(t) to the base station 4 by the downlink signal.

Relative deviations may occur in the sample timings among the LOT reception systems #1 to #N_{R}. The deviations may affect separation and demodulation of the LoRa (registered trademark) signals. Therefore, the timing correction unit 43 of the base station 4 performs two-dimensional correlation detection using the known signal section of the LoRa (registered trademark) signal on the waveform data yₙ(t) of the timing correction signal.

A timing at which the head of the known signal included in the reception signal of the IoT reception system #n is sampled is defined as Tₙ, and x_{1,f}(t) is defined as a transmitted known signal to which a frequency shift of f [Hz] is added. x_{1,f}(t) is commonly used in the IoT reception systems #1 to #N_{R}. The transmitted known signal x_{1,f}(t) is obtained by adding the frequency shift f to the known signal section in the signal format of the LPWA method used for the timing correction signal. When the assumed range of the Doppler shift is −dfₘₐₓ to dfₘₐₓ, the frequency shift f takes values of −dfₘₐₓ, −dfₘₐₓ+fₛₜₑₚ, −dfₘₐₓ+2×fₛₜₑₚ, . . . , dfₘₐₓ−fₛₜₑₚ, and dfₘₐₓ. The timing correction unit 43 uses each transmitted known signal x_{1,f}(t) while changing the value of the delay time τ for each IoT reception system #n, selects the value of τ when the correlation value with the waveform data yₙ(t) is maximum according to the following Expression (1), and defines the value of t−τ as timing Tₙ. In addition, * on the right shoulder indicates a complex conjugate. The timing Tₙ corresponds to the sample timing of the head of the known signal section included in the timing correction signal.

$$\begin{matrix}[ Math . 1 ] & \\ {T}_{1} = {arg max}_{τ , f} \int {y}_{1}^{*} ( t - τ ) \cdot {x}_{1 , f} ( t ) & ( 1 )\end{matrix}$$

$${T}_{2} = {arg max}_{τ , f} \int {y}_{2}^{*} ( t - τ ) \cdot {x}_{1 , f} ( t )$$

$${T}_{3} = {arg max}_{τ , f} \int {y}_{3}^{*} ( t - τ ) \cdot {x}_{1 , f} ( t )$$

The timing correction unit 43 obtains waveform data zₖ(t) by adjusting the timing of the waveform data yₖ(t) on the basis of a difference Tₖ−Tⱼ between the timing Tⱼ detected for the IoT reception system #j (j is any integer that is equal to or greater than 1 and equal to or less than N_{R}) and the timing Tₖ detected for the IoT reception system #k (k≠j, k is an integer that is equal to or greater than 1 and equal to or less than N_{R}). FIG. 2 illustrates a case where j=1.

Specifically, the timing correction unit 43 outputs the waveform data y₁(t) of the IoT reception system #1 as it is to the signal processing unit 44 as waveform data z₁(t). In addition, the timing correction unit 43 calculates a deviation in timings between the waveform data y₁(t) and the waveform data y₂(t) by T₂−T₁. T₂−T₁ is equal to a difference Δ₂−Δ₁ between the sampling delay Δ₂ in the IoT reception system #2 and the sampling delay Δ₁ in the IoT reception system #1. The timing correction unit 43 adjusts the timing of the waveform data y₂(t) with the timing correction value (T₂−T₁) to thereby obtain waveform data z₂(t). The timing correction unit 43 outputs the waveform data z₂(t) to the signal processing unit 44.

Similarly, the timing correction unit 43 calculates a deviation in timings between the waveform data y₁(t) and the waveform data y₃(t) by T₃−T₁. T₃−T₁ is equal to a difference Δ₃−Δ₁ between the sampling delay Δ₃ in the IoT reception system #3 and the sampling delay Δ₁ in the IoT reception system #1. The timing correction unit 43 adjusts the timing of the waveform data y₃(t) with the timing correction value (T₃−T₁) to thereby obtain waveform data z₃(t). The timing correction unit 43 outputs the waveform data z₃(t) to the signal processing unit 44.

As described above, the sample timings of the waveform data z₁(t) to z₃(t) are all aligned after Δt₁ from the reception clock time t in the antennas 31-1 to 31-3 by correcting the deviations in the relative timings among the IoT reception systems.

As described above, the timing correction unit 43 detects the timings T₁ to INR of the known signals included in the waveform data of the IoT reception systems #1 to #N_{R} using the timing correction signal from the reference station 5, and calculates the timing correction value (Tₖ−Tⱼ) of another IoT reception system #k with reference to the timing Tⱼ of a certain IoT reception system #j. The timing correction unit 43 defines the timing correction value as zero for the IoT reception system #j and outputs the waveform data yⱼ(t) as it is as waveform data zⱼ(t) to the signal processing unit 44. The timing correction unit 43 outputs waveform data zₖ(t) obtained by correcting the timing with the timing correction value (Tₖ−Tⱼ) for the waveform data yₖ(t) of the IoT reception system #k to the signal processing unit 44. The signal processing unit 44-m performs frame detection of the LPWA method #m, signal separation by reception beam control, and decoding processing.

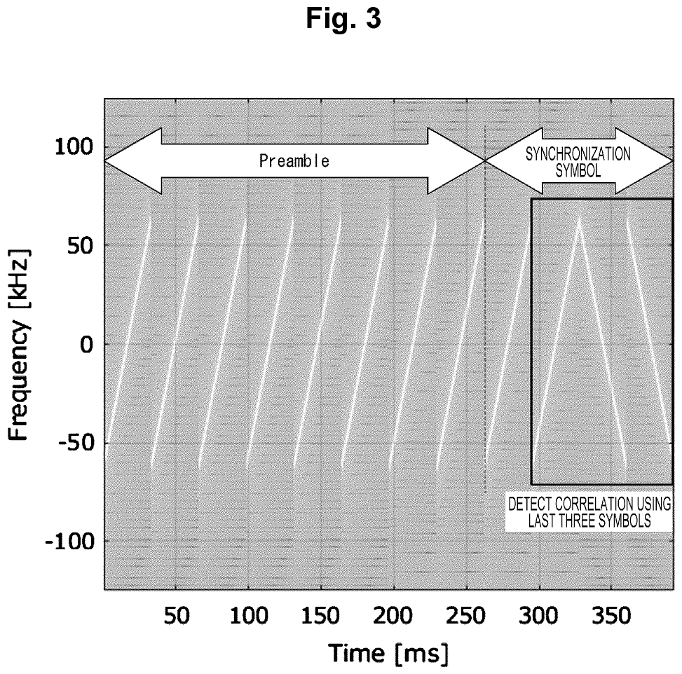

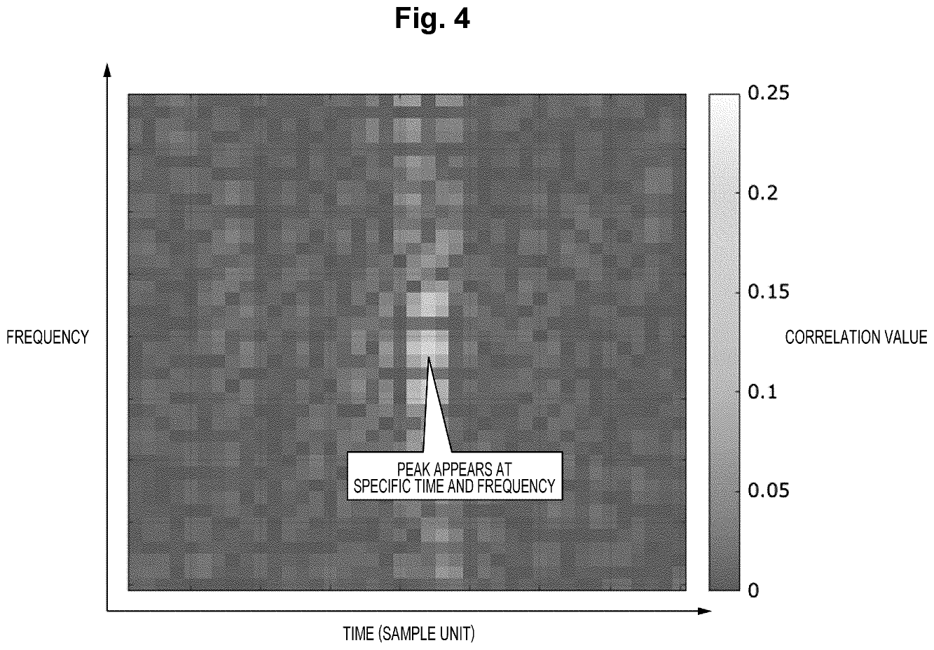

FIG. 3 is a diagram illustrating a known signal section included in the LoRa (registered trademark) frame, and FIG. 4 is a diagram illustrating a two-dimensional distribution of correlation values obtained by performing correlation detection using the known signal section of LoRa (registered trademark). As illustrated in FIG. 3, the (registered known signal section at the head of the LoRa trademark) frame includes a preamble and synchronization symbols. FIG. 4 illustrates a two-dimensional distribution of correlation values in a case where correlation detection with waveform data is performed using the last 3 symbols of the synchronization symbols in a case where the reception power is −140 dBm. As illustrated in FIG. 4, a high correlation value is obtained in a specific combination of time and frequency. In other words, it is possible to accurately detect even the reception signal subjected to the Doppler shift without deviation of one sample by performing the correlation detection in two dimensions of time and frequency.

The timing correction unit 43 may perform a three-dimensional search of the time/frequency shift/frequency variations including frequency variations for compensating for the Doppler shift variations. In a case of transmitting a terminal uplink signal of 920 MHz to the mobile relay station 3 at an orbit altitude of 570 km, for example, the assumed range of the Doppler shift is approximately −20 [KHz] to 20 [kHz], and the range of the Doppler shift variations is approximately −310 [Hz/s] to −50 [Hz/s]. In this case, the timing correction unit 43 stores in advance a transmitted known signal that is a known signal to which each combination of different types of frequency shifts f and different types of frequency variations fl is added. The plurality of types of frequency shifts f are obtained by dividing a range between −20 [kHz] and 20 [kHz] in increments of fₛₜₑₚ Hz. In addition, the plurality of types of frequency variations fl can be obtained by dividing a range between 50 Hz/s to 310 Hz/s in increments of several Hz. A necessary incrementation width varies depending on features of the signals of the LPWA method and is determined by prior system design. The timing correction unit 43 performs sliding correlation processing between the reception signal waveform indicated by the waveform data yₙ of each IoT reception system #n and each transmitted known signal to thereby obtain the timing Tₙ at which the correlation value becomes maximum.

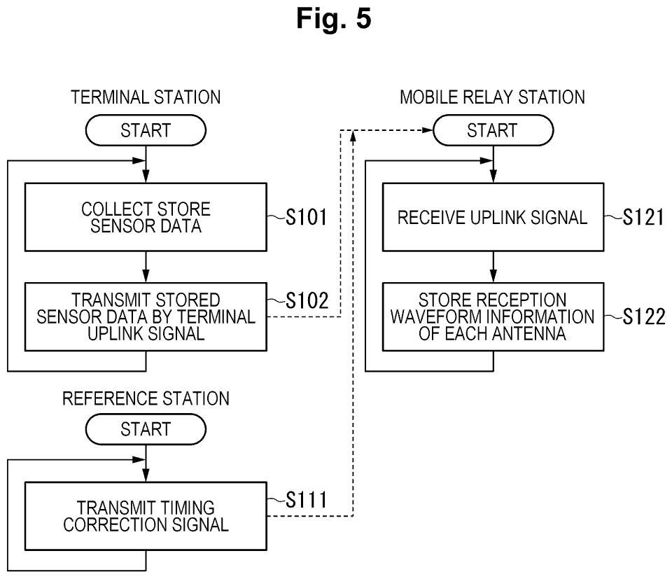

Subsequently, operations performed by the wireless communication system 1 will be described. FIG. 5 is a flowchart illustrating processing of the wireless communication system 1 in a case where the mobile relay station 3 receives an uplink signal. The terminal station 2 acquires data detected by a sensor, which is provided outside or inside and is not illustrated, at any time, and writes the acquired data in the transmission data storage unit 21 (Step S101). The transmission unit 22 reads the sensor data as the terminal transmission data from the transmission data storage unit 21 at a transmission timing of the own station and wirelessly transmits the terminal uplink signal with the terminal transmission data set from the antenna 23 (Step S102). The terminal station 2 repeats the processing from Step S101. On the other hand, the reference station 5 transmits a timing correction signal at its own transmission timing (Step S111). The reference station 5 repeats the processing from Step S111.

The reception units 32-1 to 32-N_{R} of the mobile relay station 3 receive the terminal uplink signal transmitted from the terminal station 2 and the uplink signal which is the timing correction signal transmitted from the reference station 5 (Step S121). Uplink signals at the same frequency may be simultaneously transmitted from a plurality of the terminal stations 2. In this case, the desired signals transmitted at the same frequency at the same time interfere with each other, but the signals are separated from each other by the reception beam control and can be received. The waveform sampling unit 33-n samples the waveforms of these uplink signals and writes, in the data storage unit 34, reception waveform information that associates waveform data representing the sampled waveforms, a reception clock time representing the sampling clock time, and reception system identification information representing the IoT reception system #n (Step S122). The mobile relay station 3 repeats the processing from Step S121.

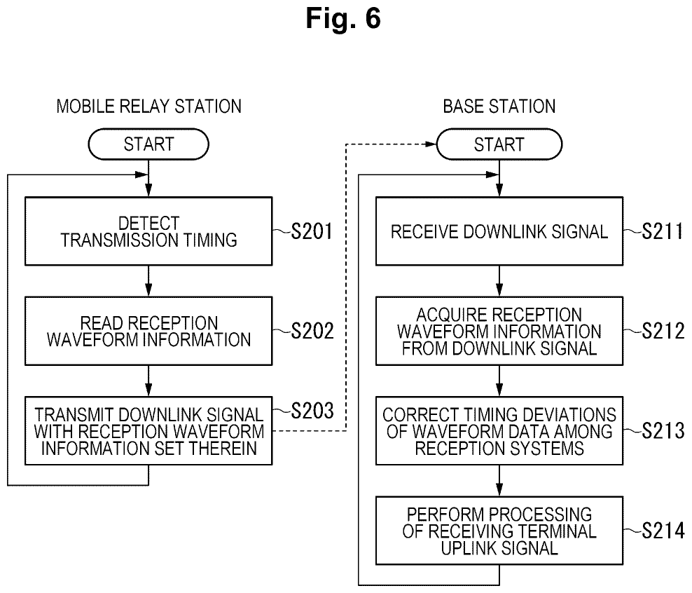

FIG. 6 is a flowchart illustrating processing of the wireless communication system 1 in a case where a downlink signal is transmitted from the mobile relay station 3. The base station communication unit 35 of the mobile relay station 3 detects that it is the transmission start timing stored in advance (Step S201). The transmission start timing is calculated in advance on the basis of the orbit information of the LEO satellite with the host station mounted thereon and the position of the base station 4, for example. The base station communication unit 35 reads reception waveform information as transmission data from the data storage unit 34 (Step S202). The base station communication unit 35 transmits a downlink signal with the acquired transmission data set therein from the antenna 36 (Step S203). The mobile relay station 3 repeats the processing from Step S201.

The base station reception unit 42 of the base station 4 receives the downlink signal using the antenna 41 (Step S211). The base station reception unit 42 demodulates and decodes the downlink signal to thereby obtain reception waveform information (Step S212). The base station reception unit 42 outputs waveform data y₁(t) to y_{NR}(t) of each of the IoT reception systems #1 to #N_{R} indicated by the reception waveform information to the timing correction unit 43.

The timing correction unit 43 detects sample timing deviations among the IoT reception systems, and performs processing of correcting the detected sample timing deviations for the waveform data y₁(t) to y_{NR}(t) (Step S213). The timing correction unit 43 outputs waveform data z₁(t) to z_{NR}(t) obtained by correcting the sample timing deviations to the signal processing unit 44.

The signal processing unit 44 performs processing of receiving terminal uplink signals indicated by the waveform data z₁(t) to z_{NR}(t) to thereby obtain the terminal transmission data transmitted from the terminal station 2 (Step S214). The base station 4 repeats the processing from Step S211.

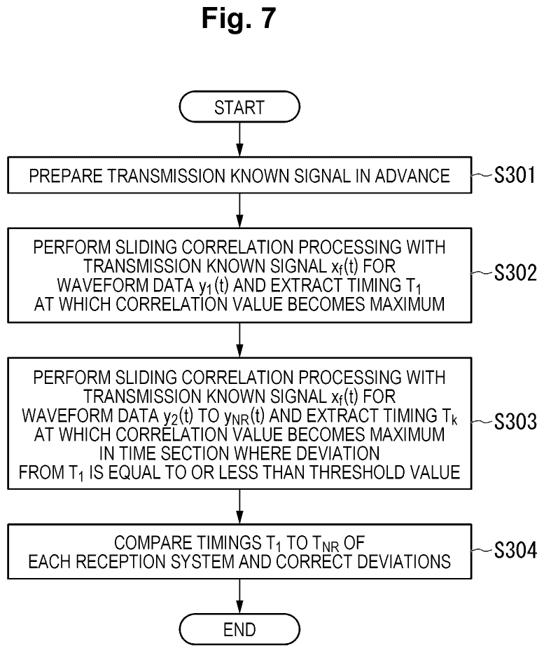

FIG. 7 is a flowchart illustrating processing performed by the timing correction unit 43 of the base station 4. The timing correction unit 43 performs timing correction processing in and after Step S302 illustrated in FIG. 7 in Step S213 in FIG. 6.

First, a transmitted known signal x_{f}(t) is prepared in advance. The transmitted known signal x_{f}(t) is obtained by adding each combination of a different frequency shift f and a different frequency variation fl to the known signal included in the timing correction signal. The timing correction unit 43 stores the transmitted known signal x_{f}(t) (Step S301). In a case where the timing correction unit 43 has already stored the transmitted known signal, the processing of Step S301 may not be performed.

The timing correction unit 43 performs sliding correlation processing between the waveform data y₁(t) and each transmitted known signal x_{f}(t) and obtains the start time of the reception signal waveform in the waveform data y₁(t) when the correlation value is maximum as the timing T₁ (Step S302).

Subsequently, the timing correction unit 43 defines each piece of the waveform data y₂(t) and y_{NR}(t) as waveform data yₖ(t). The timing correction unit 43 performs sliding correlation processing between the waveform data yₖ(t) and each transmitted known signal x_{f}(t) for each IoT reception system and obtains, as a timing Tₖ, a start timing of the reception signal waveform when the correlation value is the maximum in the time section of the waveform data yₖ(t) where the deviations from the timing T₁ are equal to or less than a threshold value (Step S303). A maximum value of the sample timing deviation amount among the IoT reception systems occurring in the waveform sampling units 33-1 to 33-N_{R} of the mobile relay station 3 is measured and grasped in advance, and a value that is equal to or greater than the maximum value is set as the threshold value. If the value is too larger than the maximum value, false detection is caused in a case where another LoRa (registered trademark) signal arrives with a minute time delay.

The timing correction unit 43 compares the timings T₁ to INR extracted in the IoT reception systems #1 to #N, adjusts the delay of the waveform data y₁(t) to y_{NR}(t) such that the relative timing deviations among the IoT reception systems become 0, and then outputs the waveform data to the subsequent signal processing unit 44 (Step S304). In other words, the timing correction unit 43 outputs the waveform data y₁(t) as it is as the waveform data z₁(t) to the signal processing unit 44, and outputs the waveform data zₖ(t) with the timing deviation (Tₖ−T₁) adjusted to the signal processing unit 44 for the waveform data yₖ(t).

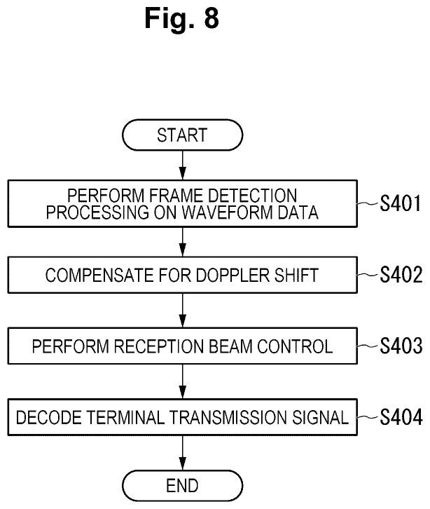

FIG. 8 is a flowchart illustrating processing of the signal processing unit 44 of the base station 4. In Step S214 of FIG. 6, each of the signal processing units 44-1 to 44-M performs the processing illustrated in FIG. 8. Here, the processing of FIG. 8 will be described using the signal processing unit 44-m as an example.

The frame detection unit 441-m inputs the waveform data z₁(t) to z_{NR}(t) of each of the IoT reception systems #1 to #N_{R} from the timing correction unit 43. The frame detection unit 441 performs frame detection processing of detecting the frame of the LPWA method #m for the input waveform data z₁(t) to z_{NR}(t) (Step S401).

The frame detection unit 441-m stores in advance a plurality of transmitted known signals of the LPWA method #m in a storage unit inside or outside the frame detection unit 441. Each transmitted known signal is obtained by adding each combination of different types of frequency shifts and different types of frequency variations to a known signal defined by the frame format of the LPWA method #m. The known signal of the LPWA method #m is a preamble or the like set at a predetermined position such as a frame head in the frame.

The frame detection unit 441-m calculates a correlation value by sliding correlation processing between each of the plurality of transmitted known signals of the LPWA method #m read from the storage unit and the reception signal waveform indicated by the waveform data zₙ(t) of each IoT reception system #n. The frame detection unit 441-m detects, for each IoT reception system #n, the frame section in the waveform data zₙ(t) on the basis of the position of the reception signal waveform where the maximum correlation value or the correlation value that is equal to or greater than the threshold has been obtained. Furthermore, the frame detection unit 441-m obtains, for each IoT reception system #n, the frequency shift and the frequency variation added to the transmitted known signal used when the frame section is detected. The obtained frequency shift and frequency variation are substantially the same as the Doppler shift and the Doppler shift variation received by the terminal uplink signal of the desired signal, respectively. Note that the frame detection unit 441-m may use the frame section, the frequency shift, and the frequency variation obtained for the waveform data zₙ(t) of any one IoT reception systems #n for another IoT reception system.

The frame detection unit 441-m extracts a section with a frame length defined by the frame format from the waveform data, or specifies a termination position of the frame on the basis of information regarding the frame length described in a header inside the reception frame, and extracts the frame section of the LPWA method #m from each piece of waveform data zₙ(t). The frame detection unit 441-m compensates for the Doppler shift in the frame section extracted from each piece of waveform data zₙ(t) (Step S402).

Specifically, the frame detection unit 441-m compensates for the Doppler shift of the frequency shift obtained for the IoT reception system #n in the frame section of the waveform data zₙ(t). Furthermore, the frame detection unit 441-m performs compensation for canceling out the Doppler shift variation by adding phase rotation for canceling out the Doppler shift variation of the frequency variation obtained for the IoT reception system #n over the entire frame section of the waveform data zₙ(t). The frame detection unit 441-m outputs the waveform data of the frame section of the IoT reception system with the Doppler shift compensated to the beam control unit 442-m.

Note that the frame detection unit 441-m may extract the frame section and the frequency shift of each IoT reception system #n similarly to the above description using the known signal of the LPWA method #m with a different frequency shift added as a transmitted known signal, and compensate for the Doppler shift of the frequency shift extracted for the extracted frame section. The frame detection unit 441-m estimates the Doppler shift variation on the basis of the phase rotation amount of the known signal section in the frame after the Doppler shift compensation for each IoT reception system #n, and compensates for the estimated Doppler shift variation for the frame section.

The beam control unit 442-m performs narrowband filtering on the waveform data in the frame section of each IoT reception system input from the frame detection unit 441-m. The pass bandwidth of the narrowband filtering is a bandwidth that is the same as the transmission signal bandwidth of the desired signal defined by the LPWA method #m or a bandwidth obtained by adding a small margin thereto. The beam control unit 442-m separates an interference signal remaining the filter band in a spatial region and extracts the desired signal by performing reception beam control based on an adaptive array on the frame subjected to the narrowband filtering (Step S403). The beam control unit 442-m outputs the extracted desired signal to the terminal signal decoding unit 443-m.

The terminal signal decoding unit 443-m performs the decoding processing on the desired signal input from the beam control unit 442-m to thereby obtain the terminal transmission data (Step S404). The terminal signal decoding unit 443-m outputs the obtained terminal transmission data. The terminal signal decoding unit 443-m may perform cyclic redundancy check (CRC) determination or the like on the decoding result and output the decoding result to a subsequent stage in a case where the decoding has successfully been performed.

According to the above embodiment, the relative sample timing deviations of the reception waveforms can be compensated for even in a case where the sample timing deviations of the reception waveforms of the uplink signals occur among the IoT reception systems. Therefore, characteristic degradation of reception beam control can be reduced.

### Modification of First Embodiment

In the first embodiment, the timing correction unit 43 of the base station 4 detects the sample timing deviations using the timing correction signal from the reference station 5. Therefore, it is necessary to install the reference station 5 in a target area where the mobile relay station 3 mounted on the LEO satellite collects data. Thus, in the modification of the first embodiment, the detection and correction of the sample timing deviations are performed using a terminal uplink signal transmitted from the terminal station 2 which is a satellite IoT terminal of the information collection target instead of the timing correction signal without using the reference station 5.

The timing correction unit 43 of the base station 4 performs the sliding correlation processing between waveform data of each IoT reception system of the terminal uplink signal received by the mobile relay station 3 and the transmitted known signal, and detects the LoRa (registered trademark) signal transmitted by any terminal station 2 in a case where the correlation value is greater than the threshold for all or a predetermined number or more IoT reception systems. The timing correction unit 43 performs processing similar to that in the first embodiment by using the waveform data of detected LoRa (registered trademark) signal instead of the waveform data of the timing correction signal in the first embodiment, and detects and corrects sample timing deviations among the IoT reception systems.

As described above, the sample timing deviations occur due to slight time differences among power-on timings of RF chips that perform waveform sampling in each IoT reception system. The sample timing deviations among the IoT reception systems does not change unless the RF chips are turned on/off. Therefore, it is only necessary for the timing correction unit 43 to detect and correct the timing deviation by detecting at least one LoRa (registered trademark) signal included in the waveform data.

### Second Embodiment

In the first embodiment, the detection and correction of the sample timing deviations are performed using the uplink signal of the predetermined LPWA method. In the second embodiment, a signal processing unit that performs reception processing of a terminal uplink signal of each LPWA method performs detection and correction of sample timing deviations, which also serve as frame detection. In the second embodiment, differences from the first embodiment will be mainly described.

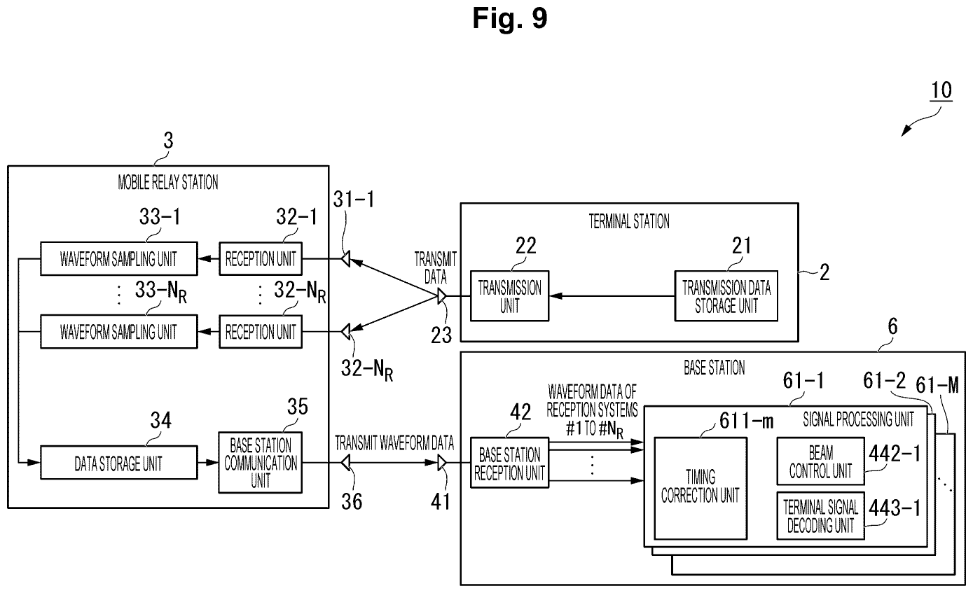

FIG. 9 is a diagram illustrating a configuration of a wireless communication system 10 according to the second embodiment. In FIG. 9, the same components as those of the wireless communication system 1 according to the first embodiment illustrated in FIG. 1 are denoted by the same reference numerals, and the description thereof will be omitted. The wireless communication system 10 includes a terminal station 2, a mobile relay station 3, and a base station 6. The base station 6 is an example of a signal processing apparatus. The base station 6 is installed on the earth. The number of base stations 6 is any number.

The base station 6 includes an antenna 41, a base station reception unit 42, and a signal processing unit 61. M (M is an integer that is equal to or greater than 1) signal processing units 61 will be referred to as signal processing units 61-1 to 61-M, respectively. Each of the plurality of signal processing units 61 performs signal processing of different LPWA method. The signal processing unit 61-m (m is an integer that is equal to or greater than 1 and equal to or less than M) corresponds to an LPWA method #m.

The signal processing unit 61 includes a timing correction unit 611, a beam control unit 442, and a terminal signal decoding unit 443. The timing correction unit 611, the beam control unit 442, and the terminal signal decoding unit 443 included in the signal processing unit 61-m will be referred to as a timing correction unit 611-m, a beam control unit 442-m, and a terminal signal decoding unit 443-m, respectively.

The timing correction unit 611-m inputs the waveform data of each of the IoT reception systems #1 to #N_{R} from the base station reception unit 42. The timing correction unit 611-m detects the terminal transmission frame of the LPWA method #m by performing sliding correlation processing of the waveform data of each of the IoT reception systems #1 to #N_{R} and the transmitted known signal of the LPWA method #m, and corrects the sample timing deviations among the IoT reception systems. The timing correction unit 611-m extracts the frame section of the LPWA method #m from the waveform data of each of the IoT reception systems #1 to #N_{R} with the sample timing deviations among the IoT reception systems corrected. The timing correction unit 611-m compensates for the Doppler shift of these extracted frame sections and then outputs the result to the beam control unit 442-m.

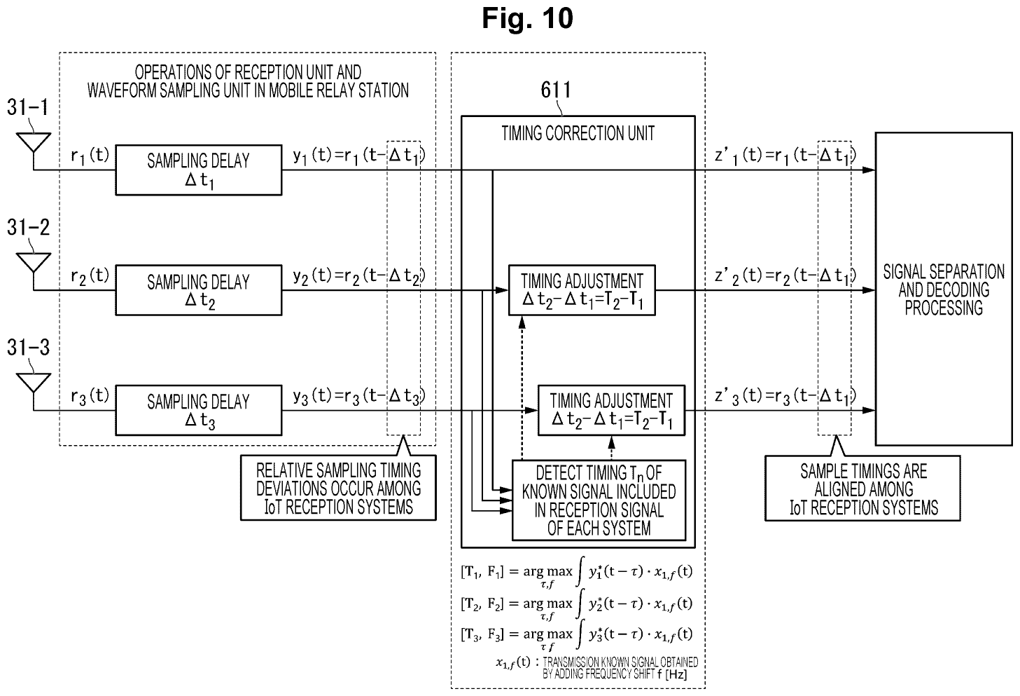

FIG. 10 is a diagram for explaining processing of detecting and correcting sample timing deviations among the IoT reception systems in the wireless communication system 10. FIG. 10 illustrates an example of a case where N_{R}=3. The detection and correction of the relative deviations of the sample timings among the IoT reception systems are performed by the base station 6 which is a ground demodulation system. The timing correction unit 611 of signal processing unit 61 of the base station 6 performs detection and correction of relative deviations of the sample timings, which also serve as frame detection of the LPWA method #m.

The mobile relay station 3 receives a terminal uplink signal from each terminal station 2. Similarly to the first embodiment, the sampling delay Δtₙ occurs until the waveform data yₙ(t) is obtained after the reception unit 32-n of the mobile relay station 3 receives the uplink signal rₙ(t) at the clock time t by the antenna 31-n. The timing correction unit 611-m of the signal processing unit 61-m of the base station 6 performs two-dimensional correlation detection using the known signal section of the LPWA method #m on the waveform data y₁(t) to y_{NR}(t) of the IoT reception systems #1 to #N_{R}.

A timing at which sampling of the known signal of the LPWA method #n included in the reception signal of the IoT reception system #n is started is defined as Tₙ, and x_{1,f}(t) is defined as a transmitted known signal of the LPWA method #m to which a frequency shift of f [Hz] is added. The frequency shift f is determined similarly to the first embodiment. The timing correction unit 611-m uses each transmitted known signal x_{1,f}(t) while changing the value of the delay time τ for each IoT reception system #n and obtains values of the timing Tₙ and the frequency shift En when the correlation value with the waveform data yₙ(t) is the maximum by the following Expression (2).

$$\begin{matrix}[ Math . 2 ] & \\ [ {T}_{1} , {F}_{1} ] = {arg max}_{τ , f} \int {y}_{1}^{*} ( t - τ ) \cdot {x}_{1 , f} ( t ) & ( 2 )\end{matrix}$$

$$[ {T}_{2} , {F}_{2} ] = {arg max}_{τ , f} \int {y}_{2}^{*} ( t - τ ) \cdot {x}_{1 , f} ( t )$$

$$[ {T}_{3} , {F}_{3} ] = {arg max}_{τ , f} \int {y}_{3}^{*} ( t - τ ) \cdot {x}_{1 , f} ( t )$$

The timing Tₙ is a value of t-τ using the value of τ when the maximum correlation value is obtained for the IoT reception system #n, and the frequency shift Fₙ is a frequency shift f added to the transmitted known signal when the maximum correlation value is obtained for the IoT reception system #n. The timing correction unit 611-m corrects the relative timing deviations of the waveform data y₁(t) to y_{NR}(t) similarly to the first embodiment using the timings T₁ to INR obtained for the IoT reception systems #1 to #N_{R}. In other words, the timing correction unit 611-m defines the timing correction value as zero for the waveform data yⱼ(t) of the IoT reception system #j (j is any integer that is equal to or greater than 1 and equal to or less than N_{R}) and defines the waveform data yⱼ(t) as it is as the waveform data zⱼ(t). The timing correction unit 611-m corrects the timing with the timing correction value (Tₖ−Tⱼ) for the waveform data yₖ(t) of the IoT reception system #k (k≠j, k is an integer that is equal to or greater than 1 and equal to or less than N_{R}) and defines it as waveform data zₖ(t). In FIG. 10, (j=1) and (k=2, 3).

The timing correction unit 611-m detects frame sections in the waveform data z₁(t) to z_{NR}(t) with the relative timing deviations corrected using the timing Tⱼ as the position of the known signal of LPWA #m. The timing correction unit 611-m extracts a section with a frame length defined by the frame format of the LPWA #m from the waveform data z₁(t) to z_{NR}(t), or specifies a termination position of the frame on the basis of information regarding the frame length described in a header inside the reception frame, and extracts the frame section.

The timing correction unit 611-m compensates for the Doppler shift of the frequency shift Fₙ obtained for the IoT reception system #n in the frame section of each extracted waveform data zₙ(t). The timing correction unit 611-m outputs waveform data z′ₙ(t) obtained by compensating for the Doppler shift of the frequency shift Fₙ in the frame section extracted from the waveform data zₙ(t) to the beam control unit 442-m. The subsequent processing is similar to that in the first embodiment.

Note that F₁=F₂= . . . =F_{NR} may not be satisfied due to an influence of noise. In this case, characteristic degradation of the beam control may occur, and the timing correction unit 611-m thus compensates for the Doppler shift by the frequency shift Fₙ obtained for any IoT reception systems #n in all the IoT reception systems #1 to #N_{R}, for example.

The timing correction unit 611-m may perform a three-dimensional search of the time/frequency shift/frequency variations including frequency variations for compensating for the Doppler shift variations. In this case, the timing correction unit 611-m stores in advance a transmitted known signal that is a known signal of the LPWA method #m to which each combination of different types of frequency shifts f and different types of frequency variations fl has been added. The timing correction unit 611-m performs sliding correlation processing between the reception signal waveform indicated by the waveform data yₙ(t) of each IoT reception system #n and each transmitted known signal. The timing correction unit 611-m obtains the timing Tₙ at which the correlation value becomes maximum for each IoT reception system #n, the frequency shift Fₙ, and the frequency variation FLₙ. The frequency shift Fₙ and the frequency variation FLₙ are the frequency shift f and the frequency variation fl added to the transmitted known signal used when the correlation value is maximum.

The timing correction unit 611-m compensates for the Doppler shift of the frequency shift Fₙ in the frame section of each waveform data zₙ(t). Furthermore, the timing correction unit 611-m performs compensation for canceling out the Doppler shift variation by adding phase rotation for canceling out the Doppler shift variation of the frequency variation FLₙ over the entire frame section of each piece of waveform data zₙ(t) and obtains the waveform data z′ₙ(t). The timing correction unit 611-m outputs the frame sections of the waveform data z′₁(t) to z′_{NR}(t) to the beam control unit 442-m.

Subsequently, operations of the wireless communication system 10 will be described. Processing of the wireless communication system 10 in a case where the mobile relay station 3 receives an uplink signal is similar to the processing in the first embodiment illustrated in FIG. 5 except for the processing of the reference station 5.

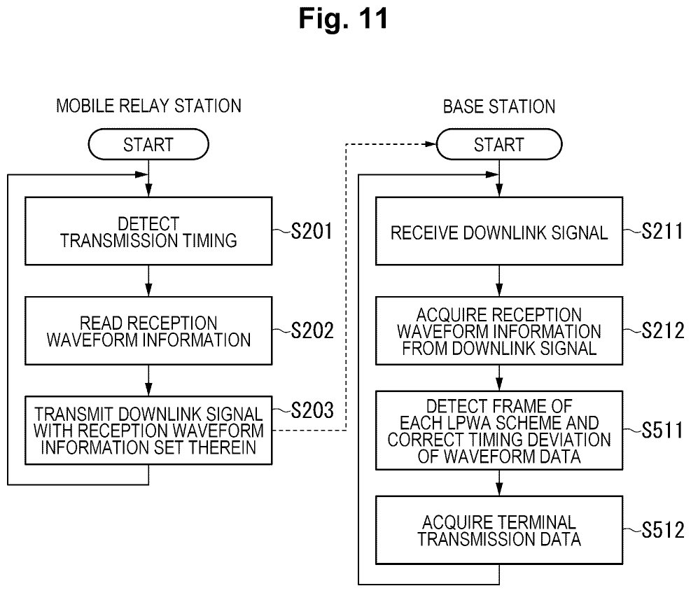

FIG. 11 is a flowchart illustrating processing of the wireless communication system 10 in a case where a downlink signal is transmitted from the mobile relay station 3. The processing of the mobile relay station 3 and the processing in Steps S211 and S212 of the base station 6 are similar to those in the first embodiment illustrated in FIG. 6. However, the base station 6 does not receive the timing correction signal.

The signal processing units 61-1 to 61-M of the base station 6 inputs waveform data y₁(t) to y_{NR}(t) of each of the LOT reception systems #1 to #N_{R} indicated by reception waveform information from the base station reception unit 42. The timing correction unit 611-m of the signal processing unit 61-m performs sliding correlation processing between the waveform data y₁(t) to y_{NR}(t) of each of the IoT reception systems #1 to #N_{R} and the transmitted known signal x_{f}(t) of the LPWA method #m. The timing correction unit 611-m detects the frames of the LPWA method #m in the waveform data y₁(t) to y_{NR}(t) on the basis of the result of the sliding correlation processing, and corrects the sample timing deviations on the basis of the detected positions (Step S511). The timing correction unit 611-m outputs the waveform data z′₁(t) to z′_{NR}(t) obtained by compensating the Doppler shift to the frame of the LPWA method #m extracted from the waveform data z₁(t) to z_{NR}(t) with the sample timing deviations corrected.

The beam control unit 442-m performs offline reception beam control using the waveform data z′₁(t) to Z′_{NR}(t) input from the timing correction unit 611-m. The terminal signal decoding unit 443-m decodes the symbol of the reception signal on which the off-line beam control has been performed by the beam control unit 442-m, and obtains terminal transmission data transmitted from the terminal station 2 (Step S512).

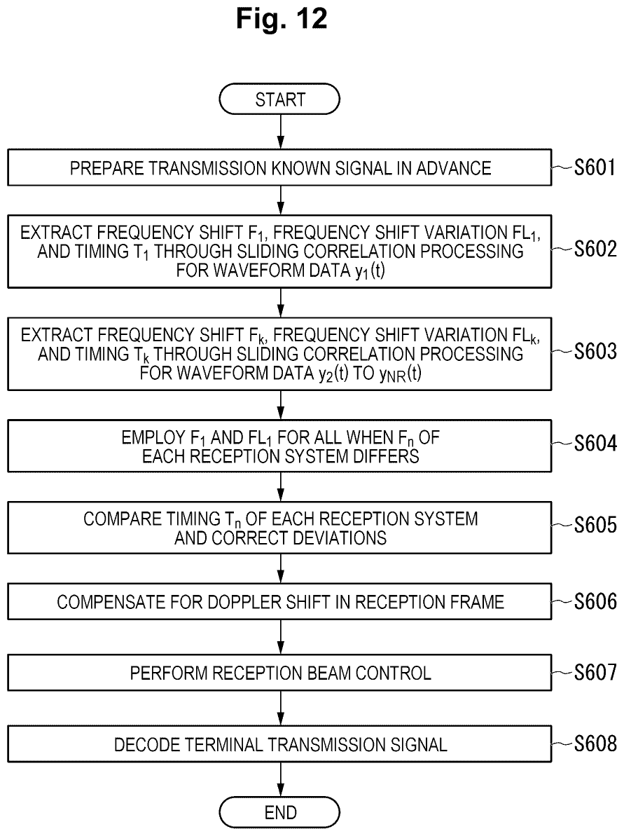

FIG. 12 is a flowchart illustrating processing of the signal processing unit 61. The signal processing unit 61 performs timing correction processing in and after Step S602 illustrated in FIG. 12 in Steps S511 and S512 in FIG. 11. Here, the processing of FIG. 12 will be described using the signal processing unit 61-m as an example.

First, a transmitted known signal x_{f}(t) of the LPWA method #m is prepared in advance. The transmitted known signal x_{f}(t) is obtained by adding a combination of a different frequency shift f and a different frequency variation fl to the known signal included in the signal frame of the LPWA method #m. The timing correction unit 611-m stores the transmitted known signal x_{f}(t) of the LPWA method #m (Step S601). In a case where the timing correction unit 611-m has already stored the transmitted known signal, the processing in Step S601 may not be performed.

The timing correction unit 611-m performs sliding correlation processing between the waveform data y₁(t) and each transmitted known signal x_{f}(t) and extracts the frequency shift F₁ and the frequency variation FL₁ with which the correlation value becomes the maximum and the timing T₁ (Step S602). The frequency shift F₁ and the frequency variation FL₁ are the frequency shift f and the frequency variation fl used to generate the transmitted known signal x_{f}(t) from which the maximum correlation value has been obtained. The timing T₁ is the start clock time of the received signal waveform in the waveform data y₁(t) when the correlation value is the maximum.

The timing correction unit 611-m defines each piece of the waveform data y₂(t) to y_{NR}(t) as waveform data yₖ. The timing correction unit 611-m performs sliding correlation processing between the waveform data yₖ and each transmitted known signal x_{f}(t) and extracts the frequency shift Fₖ and the frequency variation FLₖ with which the correlation value becomes the maximum and the timing Tₖ (Step S603) in a time section where the deviation from the timing T₁ is equal to or less than a threshold value. The frequency shift Fₖ, the frequency variation FLₖ, and the timing Tₖ are obtained similarly to the extraction of the frequency shift F₁ and the frequency variation FL₁ and the timing T₁ in Step S602. The threshold value is set similarly to Step S303 in the first embodiment illustrated in FIG. 7.

In a case where the frequency shifts F₁ to F_{NR} of the IoT reception systems are different, the timing correction unit 611-m defines all the frequency shifts and frequency variations of the IoT reception systems #1 to #N_{R} as the frequency shift F₁ and the frequency variation FL₁ of the IoT reception system #1 (Step S604).

The timing correction unit 611-m compares the timings T₁ to INR extracted in the IoT reception systems #1 to #N, and adjusts the delay of the waveform data y₁(t) to y_{NR}(t) such that the relative deviations among the IoT reception systems become 0 (Step S605). In other words, the timing correction unit 611-m defines the waveform data y₁(t) as it is as the waveform data z₁(t) and defines the waveform data zₖ(t) for the waveform data yₖ(t) by adjusting the timing deviation (Tₖ−T₁).

The timing correction unit 611-m extracts frame sections of the LPWA method #m in the waveform data z₁(t) to z_{NR}(t) using the timing T₁ as the position of the known signal in the frame of the LPWA method #m. The timing correction unit 611-m compensates for the Doppler shift of the frame section extracted from the waveform data zₙ(t) of each IoT reception system #n (Step S606). The timing correction unit 611-m compensates for the Doppler shift of the frequency shift Fₙ in the frame section of the waveform data zₙ(t), further performs compensation for canceling out the Doppler shift variation of the frequency variation FLₙ, and thereby obtains the waveform data z′ₙ(t). The timing correction unit 611-m outputs the waveform data z′₁(t) to z′_{NR}(t) to the beam control unit 442-m.

The frequency shift and the frequency variation that bring about the maximum correlation value in the above timing correction processing is a Doppler shift and a Doppler shift variation received by the reception signal due to high-speed movement of the LEO satellite. Therefore, the timing correction unit 611-m performs Doppler shift compensation for canceling it out. At this time, the frequency shift Fₙ that brings about the maximum correlation value may be slightly different for each IoT reception system due to an influence of thermal noise. If the Doppler shift compensation is performed with a different value for each IoT reception system, a signal with a frequency deviation is input to the subsequent beam control unit 442-m, which leads to characteristic degradation of the reception beam control. Therefore, the timing correction unit 661-m performs Doppler shift compensation using the transmitted known signal bringing about the maximum correlation value for an arbitrary IoT reception system.

The beam control unit 442-m performs processing similar to Step S403 in FIG. 8 using the waveform data z′₁(t) to z′_{NR}(t) input from the timing correction unit 611-m. In other words, the beam control unit 442-m performs narrowband filtering on the waveform data z′₁(t) to z′_{NR}(t), and then performs reception beam control by an adaptive array to thereby extract a desired signal (Step S607). The terminal signal decoding unit 443-m performs the processing in Step S403 in FIG. 8. In other words, the terminal signal decoding unit 443-m performs decoding processing on the desired signal input from the beam control unit 442-m and obtains terminal transmission data (Step S608).

In the above-described embodiments, the case where the moving body on which the mobile relay station is mounted is an LEO satellite has been described. However, the mobile object may be another flying object that flies through the sky, such as a geostationary satellite, a drone, or a HAPS. Further, the above embodiments are also applicable to a case where a relay station that does not move receives a radio signal from a terminal station that moves on a predetermined orbit, for example.

According to the aforementioned embodiment, it is possible to prevent characteristic degradation of reception beam control by correcting sample timing deviations even in a case where sample timing deviations of reception signals occur among the reception systems of the mobile relay station 3.

All or some of the timing correction unit 43 and the signal processing unit 44 of the base station 4 and the signal processing unit 61 of the base station 6 may be implemented by a processor such as a central processing unit (CPU), or a graphics processing unit (GPU) reading programs from the storage unit and executing them. Further, all or some of the functions of the timing correction unit 43 and the signal processing unit 44 of the base station 4 and the signal processing unit 61 of the base stations 6 may be implemented by using hardware such as an application specific integrated circuit (ASIC), a programmable logic device (PLD), or a field programmable gate array (FPGA).

Further, the base station 4 may not include the timing correction unit 43 and the signal processing unit 44, and a signal processing apparatus connected to the base station 4 may include the timing correction unit 43 and the signal processing unit 44. In addition, the base station 6 may not include the signal processing unit 61, and a signal processing apparatus connected to the base station 6 may include the signal processing unit 61.

According to the aforementioned embodiment, the signal processing apparatus includes the first timing correction unit, the frame detection unit, the beam control unit, and the decoding unit. For example, the signal processing apparatus corresponds to the base stations 4 and 6. The first timing correction unit detects sample timing deviations among a plurality of reception systems on the basis of known signal sections included in waveform data having been obtained by sampling waveforms of radio signals having been received by a communication apparatus using the plurality of reception systems and performs processing of correcting the detected sample timing deviations on the waveform data. For example, the communication apparatus is the mobile relay station 3 in the embodiment. The frame detection unit detects frames of radio signals in the waveform data with the sample timing deviations corrected and performs compensation for a Doppler shift on the detected frames. The beam control unit performs reception beam control on the plurality pieces of waveform data with the Doppler shift having been compensated. The decoding unit decodes signals having been obtained through the reception beam control and obtains data having been transmitted by the radio signals.

The communication apparatus may be provided in a flying object that flies over the sky. The first timing correction unit detects a sample timing of a timing correction signal having been wirelessly transmitted by a reference station from an area on the ground where a terminal station that transmits radio signals to the communication apparatus is installed, for each reception system based on a correlation between each of a plurality of transmitted known signals having been obtained by performing different Doppler shift compensation on a known signal of a radio signal scheme used for the timing correction signal and waveform data, and detects the sample timing deviations among the plurality of reception systems using the detected sample timing. The signal processing apparatus includes, for each radio signal scheme used for the radio signal from the terminal station, a set of a frame detection unit, a beam control unit, and a decoding unit, the set employs the radio signal scheme as a processing target. The frame detection unit detects frames of radio signals in the radio signal scheme as the processing target in the waveform data with the sample timing deviations having been corrected and performs compensation for a Doppler shift on the detected frames.

The first timing correction unit may detect a sample timing of a radio signal of a predetermined wireless communication scheme having a high timing detection resolution for each reception system on the basis of a correlation between each of a plurality of types of transmitted known signals having been obtained by performing different Doppler shift compensation on the known signal of the wireless communication scheme and waveform data, and detect the sample timing deviations among the plurality of reception systems using the detected sample timing. The signal processing apparatus includes, for each radio signal scheme used for the radio signal received by the communication apparatus, a set of a frame detection unit, a beam control unit, and a decoding unit, the set employs the radio signal scheme as a processing target. The frame detection unit detects frames of radio signals in the radio signal scheme as the processing target in the waveform data with the sample timing deviations having been corrected and performs compensation for a Doppler shift on the detected frames.

The signal processing apparatus may include a second timing correction unit instead of the first timing correction unit and the frame detection unit. The second timing correction unit detects the frames of the wireless communication scheme as a processing target in the waveform data and the sample timing deviations among the plurality of reception systems on the basis of a known signal section of the wireless communication scheme as the processing target included in the waveform data of each of the plurality of reception systems and performs compensation for a Doppler shift on the frames detected in the waveform data with the detected sample timing deviations having been corrected.

The second timing correction unit detects, for each of the reception systems, a sample timing of the known signal and the Doppler shift that the known signal has received, on the basis of a correlation between each of the plurality of transmitted known signals having been obtained by performing different Doppler shift compensation on the known signal of the wireless communication scheme as the processing target and the waveform data, detects the sample timing deviations among the plurality of reception systems using the detected sample timing, and performs compensation for the detected Doppler shift on the detected frames in the waveform data with the detected sample timing deviations having been corrected.

The second timing correction unit performs compensation for the Doppler shift detected for any of the reception systems on the frames of the plurality of reception systems.

In addition, at least some functions of the signal processing apparatus may be realized by a computer. In that case, a program for realizing the functions of the signal processing apparatus may be recorded in a computer-readable recording medium, and the functions may be realized by loading the program recorded in this recording medium to a computer system, and executing the program. Assume that the computer system includes, for example, a processor, an OS, and hardware such as peripheral devices. The program of the signal processing apparatus may be recorded on a computer-readable recording medium. The computer-readable recording medium is, for example, a portable medium such as a flexible disk, a magneto-optical disc, a ROM, or a CD-ROM or a storage device such as a hard disk built in a computer system. The program of the signal processing apparatus may be transmitted via a telecommunication line.

Although the embodiments of the present invention have been described in detail with reference to the drawings, specific configurations are not limited to the embodiments and include design and the like within the gist of the present invention.

### REFERENCE SIGNS LIST

1, 10 Wireless communication system
2 Terminal station
3 Mobile relay station
4, 6 Base station
5 Reference station
21 Transmission data storage unit
22, 51 Transmission unit
31-1 to 31-N_{R}, 36 Antenna
32-1 to 32-N_{R} Reception unit
33-1 to 33-N_{R} Waveform sampling unit
34 Data storage unit
35 Base station communication unit
41 Antenna
42 Base station reception unit
43 Timing correction unit
44-1 to 44-M, 61-1 to 61-M Signal processing unit
441-1 Frame detection unit
442-1 Beam control unit
443-1 Terminal signal decoding unit
661, 661-1 Timing correction unit

1. A signal processing apparatus comprising:
a timing correction circuitry that (i) detects sample timing deviations among a plurality of reception systems of a communication apparatus on a basis of known signal sections included in a plurality of pieces of waveform data having been obtained by sampling waveforms of radio signals having been received by each of the plurality of the reception systems and (ii) performs processing of correcting the detected sample timing deviations on the plurality of pieces of the waveform data;
a frame detection circuitry that (i) detects a plurality of frames of the radio signals in the plurality of pieces of the waveform data on which the sample timing deviations have been corrected and (ii) performs compensation for a Doppler shift on each of a plurality of the detected frames;
a beam controller that performs reception beam control on the plurality of the detected frames on which the compensation for the Doppler shift has been performed; and
a decoder that decodes signals having been obtained through the reception beam control and obtains data having been transmitted by the radio signals.

2. The signal processing apparatus according to claim 1, wherein:
the communication apparatus is included in a flying object that flies over the sky;
the timing correction circuitry (i) detects, for each of the plurality of the reception systems, each of a plurality of sample timings of a timing correction signal having been wirelessly transmitted by a reference station from an area on a ground where a terminal station that transmits a radio signal to the communication apparatus is installed on a basis of a correlation between each of a plurality of transmitted known signals having been obtained by adding different frequency shift on a known signal of a first radio communication scheme used for the timing correction signal and each of the plurality of pieces of the waveform data and (ii) detects the sample timing deviations among the plurality of the reception systems using a plurality of the detected sample timings;
the signal processing apparatus includes, for each second radio communication scheme used for the radio signal from the terminal station, a set of the frame detection circuitry, the beam controller, and the decoder; and
the frame detection circuitry (i) detects the plurality of the frames of the radio signals of the corresponding second radio communication scheme in the plurality of pieces of the waveform data on which the sample timing deviations have been corrected and (ii) performs compensation for a Doppler shift on each of a plurality of the detected frames.

3. The signal processing apparatus according to claim 1, wherein:
the timing correction circuitry (i) detects, for each of the plurality of the reception systems, each of a plurality of sample timings of a radio signal of a predetermined wireless communication scheme which is one of a plurality of wireless communication schemes and characterized by a high timing detection resolution on a basis of a correlation between each of a plurality of types of transmitted known signals having been obtained by adding different frequency shift on a known signal of the predetermined wireless communication scheme and each of the plurality of pieces of the waveform data and (ii) detects the sample timing deviations among the plurality of the reception systems using a plurality of the detected sample timings;
the signal processing apparatus includes, for each of the plurality of wireless communication schemes used for the radio signals having been received by the communication apparatus, a set of the frame detection circuitry, the beam controller, and the decoder; and
the frame detection circuitry (i) detects the plurality of the frames of the radio signals of the corresponding one of the plurality of radio communication schemes in the plurality of pieces of the waveform data on which the sample timing deviations have been corrected and (ii) performs compensation for a Doppler shift on each of the plurality of the detected frames.

4. A signal processing apparatus comprising:
a timing correction circuitry that (i) detects a plurality of frames of a target wireless communication scheme in a plurality of pieces of waveform data having been obtained by sampling waveforms of radio signals having been received by each of a plurality of reception systems of a communication apparatus and sample timing deviations among the plurality of the reception systems on a basis of known signal sections of the target wireless communication scheme included in the plurality of pieces of the waveform data and (ii) performs compensation for a Doppler shift on each of the plurality of the frames detected in the plurality of pieces of the waveform data on which the detected sample timing deviations have been corrected;
a beam controller that performs reception beam control on the plurality of the frames on which the compensation for the Doppler shift has been performed; and
a decoder that decodes signals been obtained through the reception beam control and obtains data been transmitted by the radio signals.

5. The signal processing apparatus according to claim 4,
wherein the timing correction circuitry (i) detects, for each of the plurality of the reception systems, each of a plurality of sample timings of a known signal and the Doppler shift that the known signal has received, on a basis of a correlation between each of the plurality of the transmitted known signals having been obtained by adding different frequency shift on the known signal of the target wireless communication scheme and the plurality of pieces of the waveform data, (ii) detects the sample timing deviations among the plurality of the reception systems using a plurality of the detected sample timings, and (iii) performs compensation for the detected Doppler shift on a plurality of the detected frames in the plurality of pieces of the waveform data on which the detected sample timing deviations have been corrected.

6. The signal processing apparatus according to claim 5,
wherein the timing correction circuitry performs compensation for the Doppler shift detected for any of the plurality of reception systems on the plurality of frames.

7. A signal processing method comprising:
detecting sample timing deviations among a plurality of reception systems of a communication apparatus on a basis of known signal sections included in a plurality of pieces of waveform data having been obtained by sampling waveforms of radio signals having been received by each of the plurality of the reception systems and performing processing of correcting the detected sample timing deviations on the plurality of pieces of the waveform data;
detecting a plurality of frames of the radio signals in the plurality of pieces of the waveform data on which the sample timing deviations have been corrected and performing compensation for a Doppler shift on each of a plurality of the detected plurality of frames;
performing reception beam control on the plurality of the detected frames on which the compensation for the Doppler shift has been performed; and
decoding signals having been obtained through the reception beam control and obtaining data having been transmitted by the radio signals.
